(19) United States
(12) Patent Application Publication
(10) Pub. No.: US 2012/0298738 A1
(43) Pub. Date: Nov. 29, 2012

(54) CARDS WITH GEOMETRICALLY DEFINED CARD USE AND MECHANICS

(75) Inventor: Michael Northen, San Francisco, CA (US)

(73) Assignee: NUKOTOYS, INC., San Francisco, CA (US)

(21) Appl. No.: 13/479,159

(22) Filed: May 23, 2012

Related U.S. Application Data
(60) Provisional application No. 61/490,000, filed on May 25, 2011.

(51) Int. Cl. G06K 19/067; G06F 17/00; G06K 7/08

(52) U.S. Cl. 235/375; 235/492; 235/451

(57) ABSTRACT

Cards with geometrically defined card use and mechanics are disclosed. In some embodiments, a card includes a device interface zone, in which the device interface zone includes an embedded code; and a user interface zone, in which the user interface zone is for a user to hold the card. In some embodiments, the card further includes a user device bridge, in which the user device bridge connects the device interface zone and the user interface zone (e.g., including an electrical interconnection path between the device interface zone and the user interface zone). In some embodiments, the user device bridge is relatively more flexible than the device interface zone, which facilitates a user holding the card by the user interface zone and placing the card in flush contact with a capacitive screen of a touch screen device for effectively and accurately reading the embedded code on the card (e.g., printed codes).

CROSS REFERENCE TO OTHER APPLICATIONS

This application claims priority to U.S. Provisional Patent Application No. 61/490,000 (Attorney Docket No. NUKOP002+) entitled CARDS WITH GEOMETRICALLY DEFINED CARD USE AND MECHANICS filed May 25, 2011 which is incorporated herein by reference for all purposes.

### BACKGROUND OF THE INVENTION

Various printing techniques exist. For example, various printing techniques can be used to print embedded codes. For certain applications, such as where the flexibility of the material is important, various printing techniques can be applied for printing codes on paper.

### BRIEF DESCRIPTION OF THE DRAWINGS

Various embodiments of the invention are disclosed in the following detailed description and the accompanying drawings.

FIG. 1 illustrates a card with embedded code readable by a touch screen device or other contact reading technology that includes a device interface portion and a user interface portion in accordance with some embodiments.

FIG. 2 illustrates another card with embedded code that includes a device interface portion and a user interface portion in accordance with some embodiments.

FIG. 3 illustrates another card with embedded code that includes a device interface portion and a user interface portion in accordance with some embodiments.

FIG. 4A is a side view of a card with embedded code that includes a device interface portion and a user interface portion in accordance with some embodiments.

FIG. 4B is a functional diagram illustrating the use of a card with embedded code that includes a device interface portion and a user interface portion with a touch screen device for reading the card in accordance with some embodiments.

FIG. 5 illustrates another card with embedded code that includes a device interface portion and a user interface portion in accordance with some embodiments.

FIG. 6 illustrates another card with embedded code that includes a device interface portion and a user interface portion in accordance with some embodiments.

FIG. 7 illustrates another card with embedded code that includes a device interface portion and a user interface portion in accordance with some embodiments.

FIG. 8 illustrates another card with embedded code that includes a device interface portion and a user interface portion in accordance with some embodiments.

FIG. 9 illustrates another card with embedded code that includes a device interface portion and a user interface portion in accordance with some embodiments.

FIG. 10 illustrates another card with embedded code that includes a device interface portion and a user interface portion in accordance with some embodiments.

FIG. 11A is another view of a card with embedded code that includes a device interface portion and a user interface portion.

FIG. 11B is a functional diagram illustrating the use of a card in use during an attempted reading of the embedded code on the card when the user interface zone overlaps with the device interface zone.

FIG. 12 illustrates a card with embedded code and various devices capable of reading the embedded code on the card in accordance with some embodiments.

FIG. 13 is a flow diagram illustrating a process for using a card with embedded code with an online game in accordance with some embodiments.

FIG. 14 illustrates a three dimensional (3-D) object with embedded code that includes a device interface portion and a user interface portion in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various types of commercial solutions exist for producing cards with conductive patterns. Conductive materials can be ‘printed’ on paper, plastic sheets, and/or other types of flexible or relatively non-rigid materials. For example, cards (e.g., trading cards, cards for games, and/or various other applications) can be fabricated with integrated conductive materials.

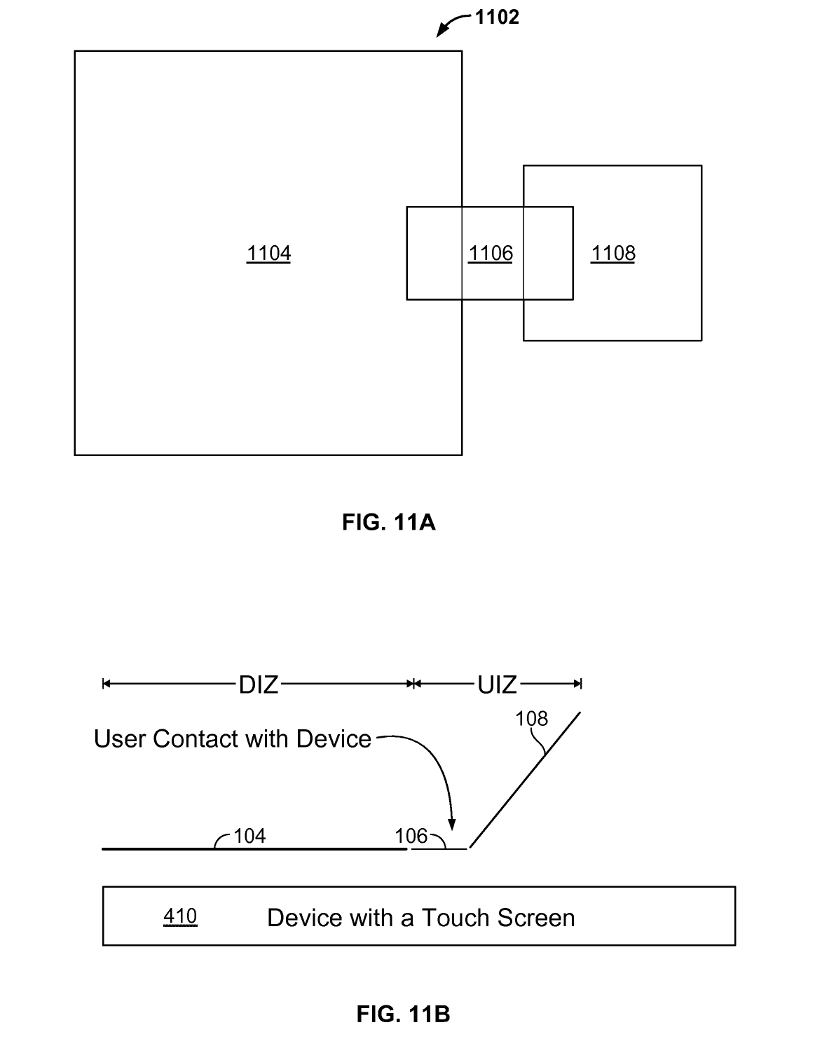

However, users can improperly interfere with an effective and accurate reading of the embedded code by a reading device (e.g., if the user does not properly hold the card to provide a ground function or by contacting the backside of the card, while that card is in contact with the screen, as described further below). For example, as described below and shown in FIG. 11, if the user interface zone (UIZ) and the device interface zone (DIZ) overlap, then the user directly contacts the device. As a result, this will likely result in an erroneous reading of the embedded code on the card.

Thus, what are needed are new and improved techniques for providing cards with geometrically defined card use and mechanics. Accordingly, cards with geometrically defined card use and mechanics are disclosed. For example, cards with embedded codes that are designed with geometrically defined card use and mechanics techniques as disclosed herein can be used intuitively and robustly by users and read effectively with various devices are provided.

In some embodiments, a card with embedded code includes a device interface zone, in which the device interface zone includes a code readable by the device (e.g., embedded code); and a user interface zone, in which the user interface zone is for a user to hold the card (e.g., a portion of the card for the user to hold the card without interfering with the device interface zone when the user places the card flush to a touch screen device for reading an embedded code on the device interface zone portion of the card). In some embodiments, the card further includes a user device bridge, in which the user device bridge connects the device interface zone and the user interface zone (e.g., the user device bridge can also include an electrical interconnection path between the device interface zone and the user interface zone). In some embodiments, the user device bridge is relatively more flexible than the device interface zone, which facilitates a user holding the card by the user interface zone and placing the card in flush contact with a capacitive screen of a touch screen device for effectively and accurately reading the embedded code on the card (e.g., a printed code on the card).

In some embodiments, the device interface zone is directly connected to the user interface zone (e.g., no user device bridge is provided).

In some embodiments, mechanisms for prescribed bending to enhance user-device interaction with cards with embedded code are disclosed. For example, trading cards with embedded code that provide for prescribed bending can be provided using the various techniques described herein.

In some embodiments, mechanisms for isolated bending in cards with embedded code are disclosed. For example, trading cards with embedded code that provide for isolated bending can be provided using the various techniques described herein.

In some embodiments, mechanisms for improved connectivity for trading cards with embedded code to various touch screen devices are disclosed. For example, trading cards with embedded code that provide for improved connectivity to various touch screen devices can be provided using the various techniques described herein.

In some embodiments, a card is provided that allows for a user to effectively and intuitively establish a robust conductive connection between the card and various forms/types of touch screen device that can include functions (e.g., software or other applications) for reading the code printed on the card. For example, the user can hold the card in one of the user's hands so as to facilitate a physical contact between the surface of the card with the embedded code and a surface of the touch screen device. The card can include a code on the screen contacting portion of the card (e.g., sometimes referred to herein as the device interface zone (DIZ)) that needs to be electrically connected to the user. The portion of the card that the user holds can include a pad that is connected to the code portion of the card (e.g., sometimes referred to herein as the user interface zone (UIZ)). This approach allows for both the mechanical and electrical connection of the user to the touch screen of the device. The portion that contacts the screen generally should remain flat or nearly flat so as to maintain a flush connection with the touch screen of the device. In some embodiments, by providing a thinner (e.g., from top view of card) flexor member to the card (e.g., sometimes referred to herein as the user device bridge (UDB)), bending is introduced into flexor member instead of the portion contacting the card. This approach thereby improves read performance of embedded codes on cards (e.g., trading cards with embedded code), card longevity, and user experience.

In some embodiments, the portion held by the user is arbitrary (e.g., various designs can be effectively used for the UDZ portion of the card, such as the various sizes and shapes of UDZ portions of cards described herein and shown with respect to various figures). For example, from a user experience, however, it can be desirable to make the user held portion larger than the flexor member and smaller than the touch screen contacting portion of the card. This approach for an intuitive user experience for holding and using the card can also improve the functionality and effective usability of the card, as further described below with respect to various embodiments.

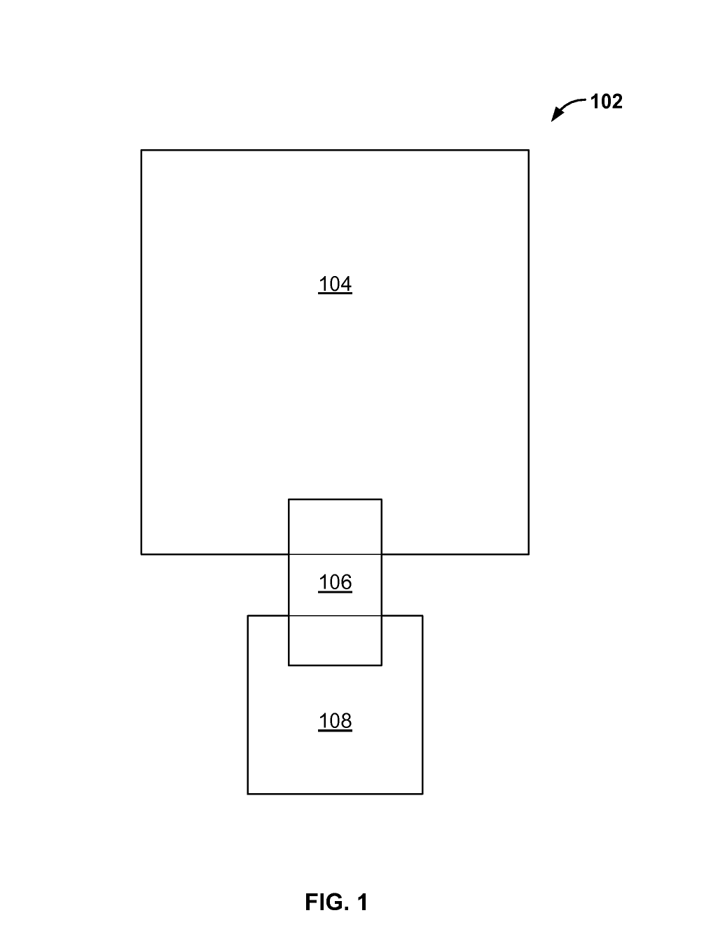

FIG. 1 illustrates a card with embedded code that includes a device interface portion and a user interface portion in accordance with some embodiments. As shown, the card 102 includes three areas. The first area, shown as area 104, is the device interface zone (DIZ). The second area, shown as area 106, is the user device bridge (UDB). The third area, shown as area 108, is the user interface zone (UIZ).

In some embodiments, the device interface zone area 104 is provided as an area that generally is designed to remain planar, or relatively flat. For example, because the code (e.g., printed using various printing techniques) generally requires a surface contact or near surface contact across a certain area (e.g., for effective reading of the embedded code using a touch screen device, such as a device that includes a capacitive touch screen), this portion generally needs to remain flat or nearly flat. With the greater width than the rest of the card, this portion can be less flexible and subsequently less susceptible to flexion. In some embodiments, the device interface zone is made of a more rigid, less flexible material than the other areas. For example, the device interface zone can be a thicker, more rigid card paper, or a stiffer plastic material, or another type of relatively rigid material.

In some embodiments, the user device bridge area 106 is provided as an area that is a smaller area (e.g., thinner bridge connector) between the device interface zone 104 and the user interface zone 108. For example, due to a thinner geometry, the structure of the user device bridge can be more flexible, causing it to flex before the device interface zone (e.g., even if the two areas are made of the same or similar materials). The thinner cross section can also improve the rotational flexibility. This allows for the user device bridge to act as a rotational compensation mechanism between the device interface zone and the user interface zone (e.g., a user's hand does not have to be perfectly aligned with the screen of the touch screen device for the card to lay flat or flush against the screen). In some embodiments, the user device bridge provides a flexible yet durable interconnection between the device interface zone and the user interface zone. In some embodiments, the user device bridge is made of a more flexible, less rigid material than the device interface zone. For example, the user device bridge zone can be a thinner, less rigid card paper, or a thinner, less rigid plastic material, or another type of relatively flexible material.

In some embodiments, the user interface zone area 108 is the area that the user makes mechanical and/or electrical contact with the card (e.g., a user tab or holding portion of the card with embedded code). In some embodiments, the user interface zone is made of the same material as the device interface zone and the user device bridge. In some embodiments, the user interface zone is made of a different material than the device interface zone and/or the user device bridge. For example, the user interface zone can be made of a material or include a surface coating that is durable to user hand contact and/or conducive to a user hand contact (e.g., non-slip and/or other grip friendly design features).

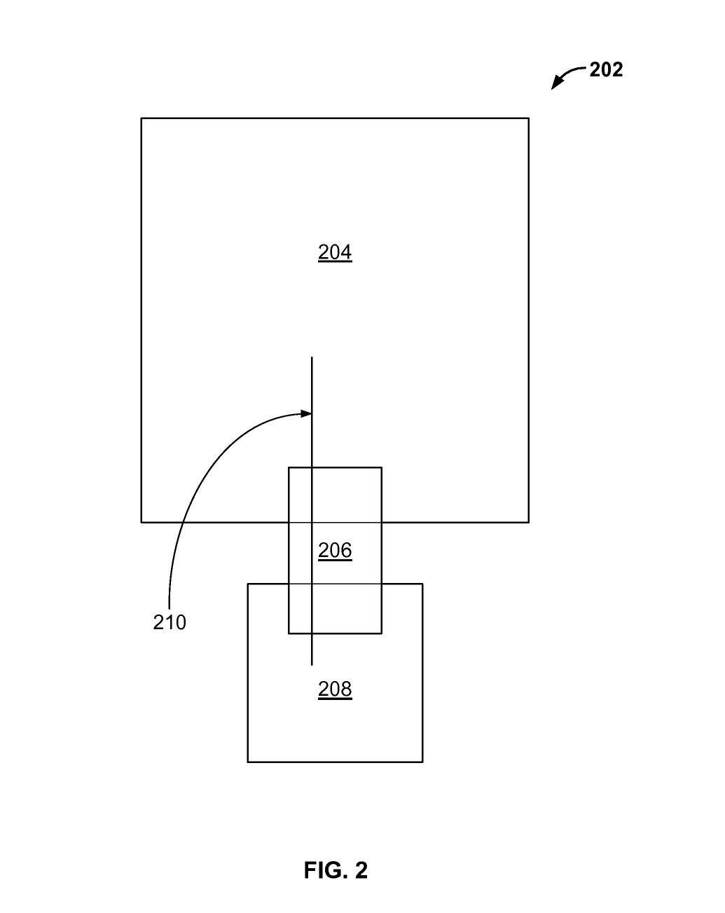

FIG. 2 illustrates another card with embedded code that includes a device interface portion and a user interface portion in accordance with some embodiments. In some embodiments, the card 202 includes three distinct electrical areas. The first area, shown as area 204, is the device interface zone and includes an embedded code (e.g., a printed code). The second area, shown as area 206, is the user device bridge and includes an electrical interconnection path 210 between the device interface zone and the user interface zone. The third area, shown as area 208, is the user interface zone and includes a user contact pad.

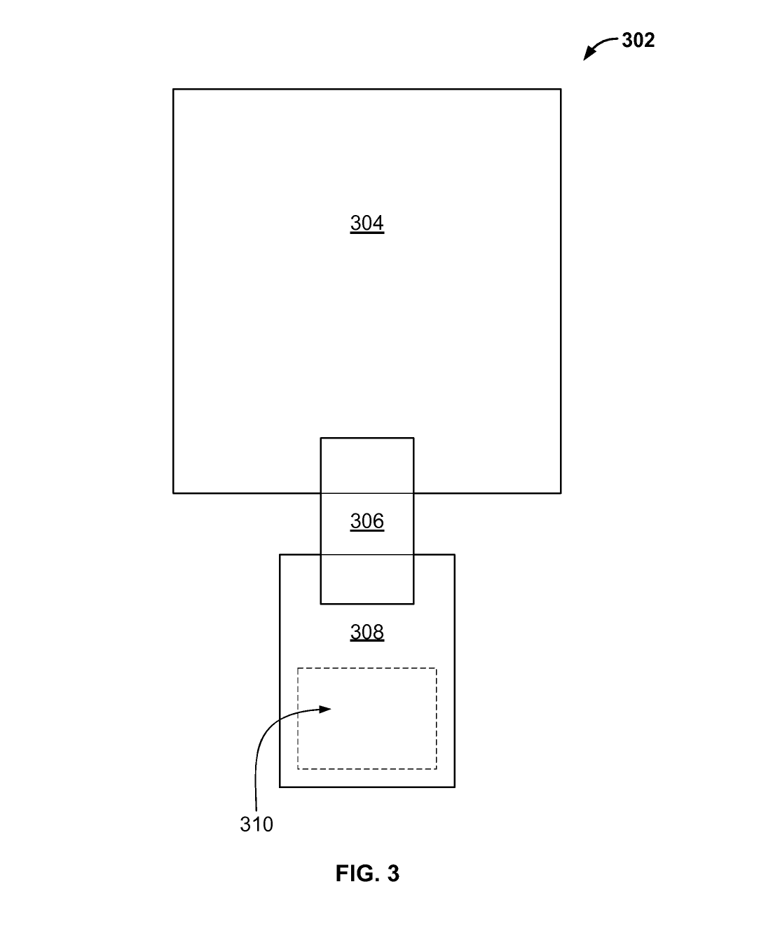

FIG. 3 illustrates another card with embedded code that includes a device interface portion and a user interface portion in accordance with some embodiments. In some embodiments, the card 302 includes three distinct electrical areas. The first area, shown as area 304, is the device interface zone and includes a portion that makes contact with a device (e.g., a touch screen of a capacitive touch screen device). The second area, shown as area 306, is the user device bridge and includes a flexor member that connects the screen-contacting portion of the device interface zone with the user mechanical contact portion of the user interface zone. The third area, shown as area 308, is the user interface zone and includes a user holding pad 310 where the user interfaces with the device (e.g., where the holds the card with the user's hand).

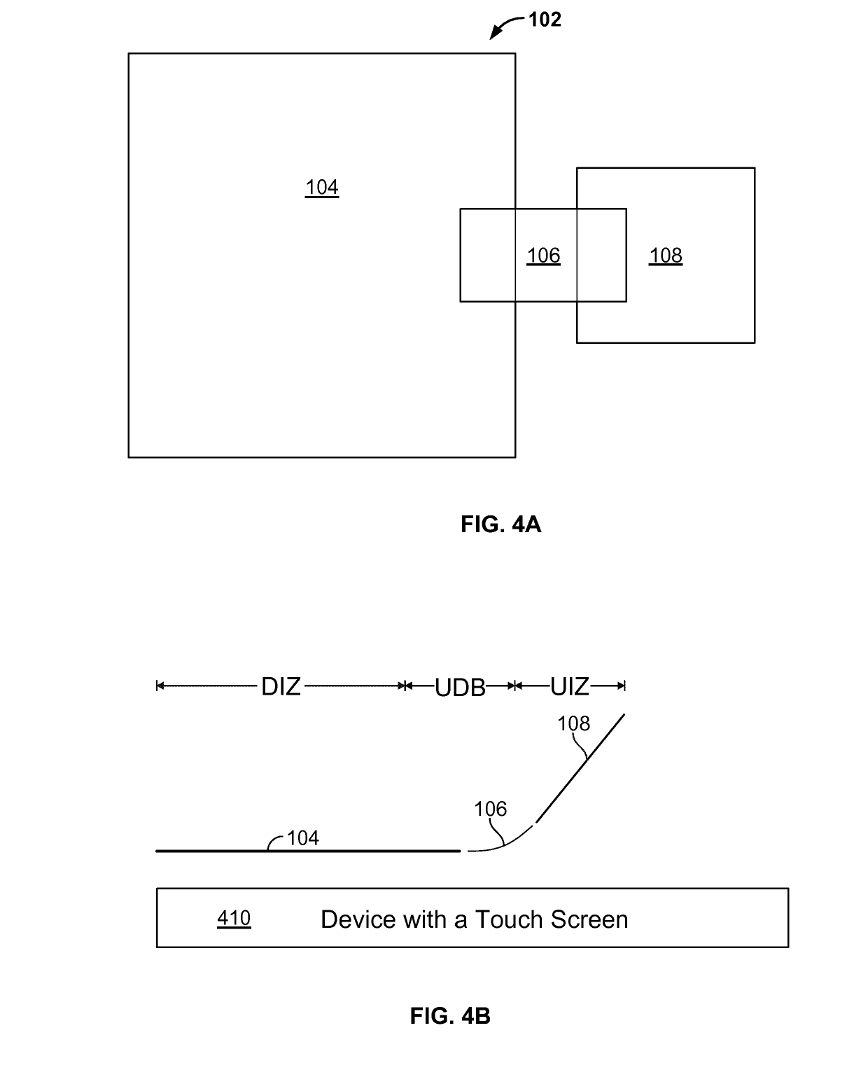

FIG. 4A is another view of a card with embedded code that includes a device interface portion and a user interface portion in accordance with some embodiments. As shown, FIG. 4A illustrates the card 102 of FIG. 1 from a rotated left view that includes a device interface zone 104, a device bridge 106, and a user interface zone 108.

FIG. 4B is a functional diagram illustrating the use of a card with embedded code that includes a device interface portion and a user interface portion with a touch screen device for reading the card in accordance with some embodiments. As shown, FIG. 11B illustrates a side view of the card 102 of FIG. 4A as it is being placed in contact with a touch screen device 410 such that the device interface zone (DIZ) 104 is in flush contact with the touch screen of the device 410. In some embodiments, the card 102 is placed in contact with a touch screen of a capacitive touch screen device. The device interface zone (DIZ) 104 is held in contact with the touch screen of the device 410 by a user's holding of the card by the user interface zone (UIZ) 108, which is connected to the device interface zone via the user device bridge (UDB) 106. As shown, the UDB 106 flexes to accommodate for the out of plane difference between the user interface zone 108 and the device interface zone 104.

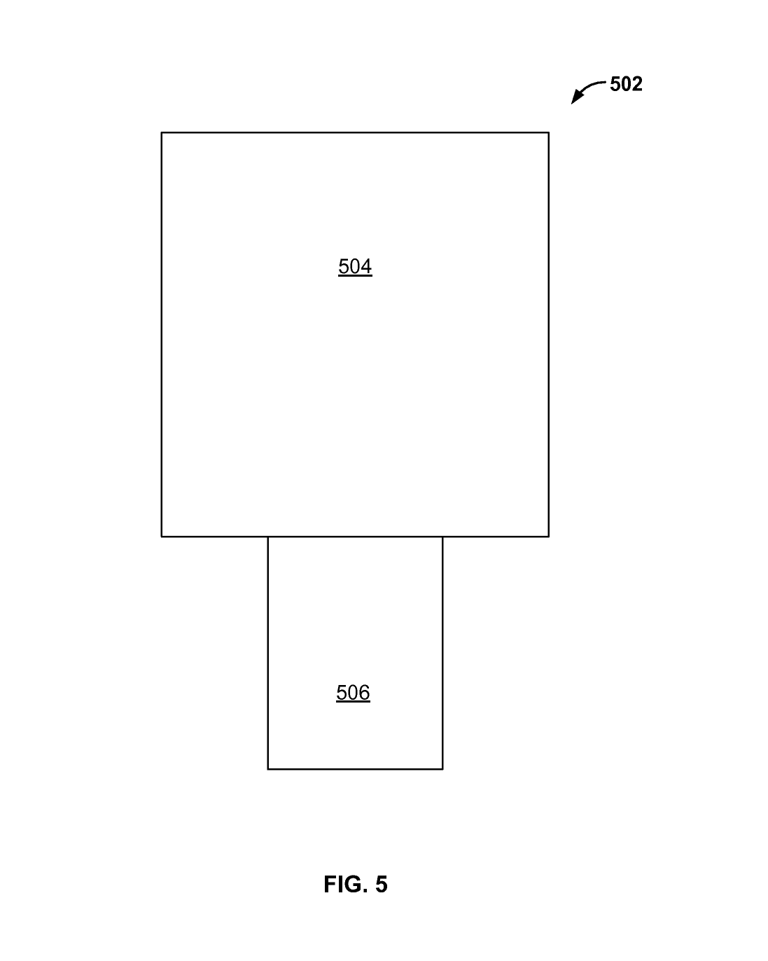

FIG. 5 illustrates another card with embedded code that includes a device interface portion and a user interface portion in accordance with some embodiments. In some embodiments, the card 502 has a large device interface zone 504, a relatively smaller user device bridge area (not shown), and relatively smaller user interface zone area 506.

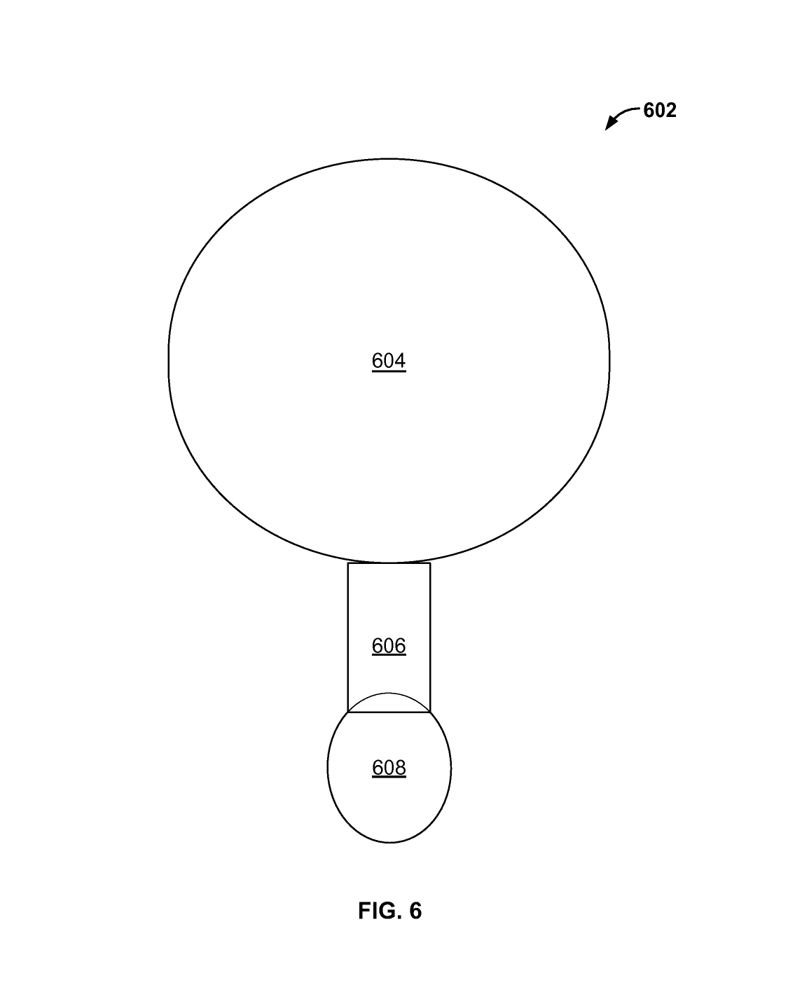

FIG. 6 illustrates another card with embedded code that includes a device interface portion and a user interface portion in accordance with some embodiments. In some embodiments, the card 502 includes a device interface zone 604 and user interface zone 608 that are elliptical in shape. The user device bridge 606 is shown as relatively thinner in width.

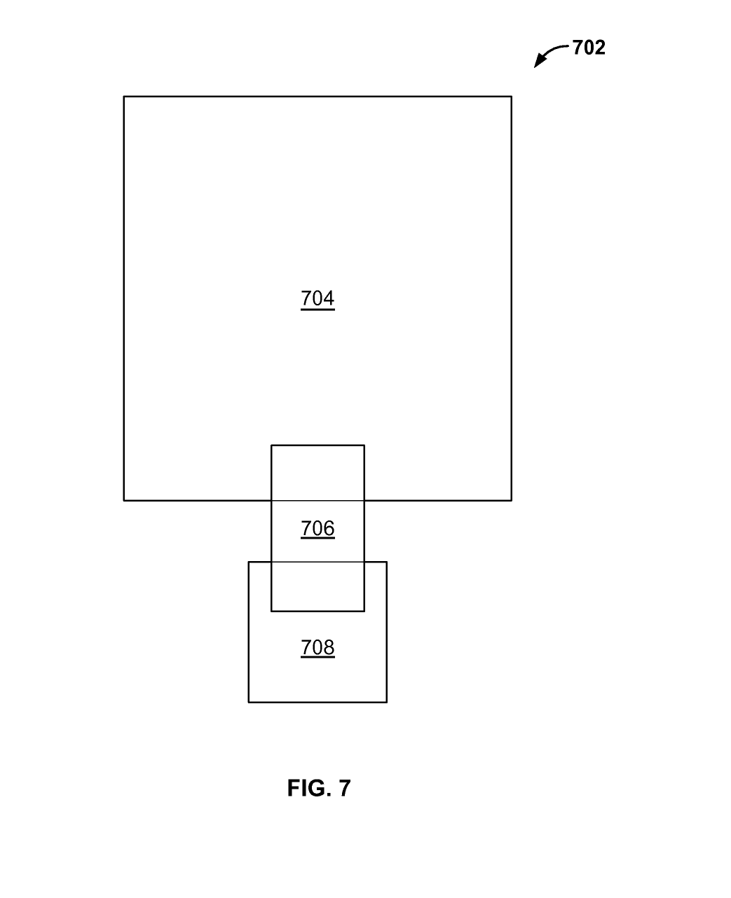

FIG. 7 illustrates another card with embedded code that includes a device interface portion and a user interface portion in accordance with some embodiments. In some embodiments, the card 702 includes a device interface zone 704 that is relatively larger in area than each of the user device bridge 706 and the user interface zone 708. As shown, each of these areas is rectilinear in shape.

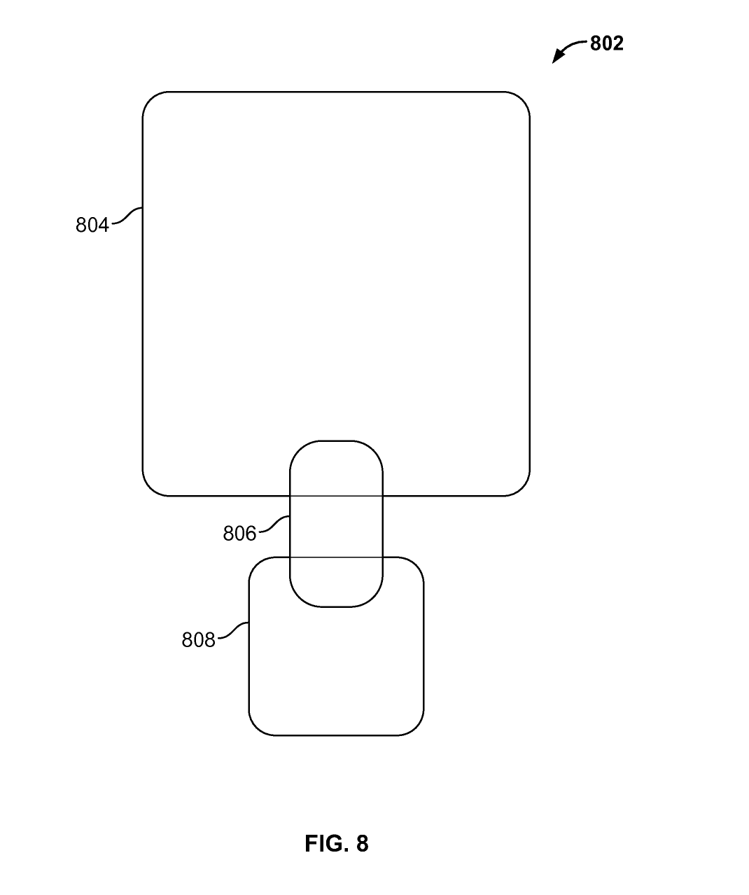

FIG. 8 illustrates another card with embedded code that includes a device interface portion and a user interface portion in accordance with some embodiments. In some embodiments, the card 802 includes a device interface zone 804 that is relatively larger in area than each of the user device bridge 806 and the user interface zone 808. As shown, each of these areas is rectilinear with rounded interior and exterior corners.

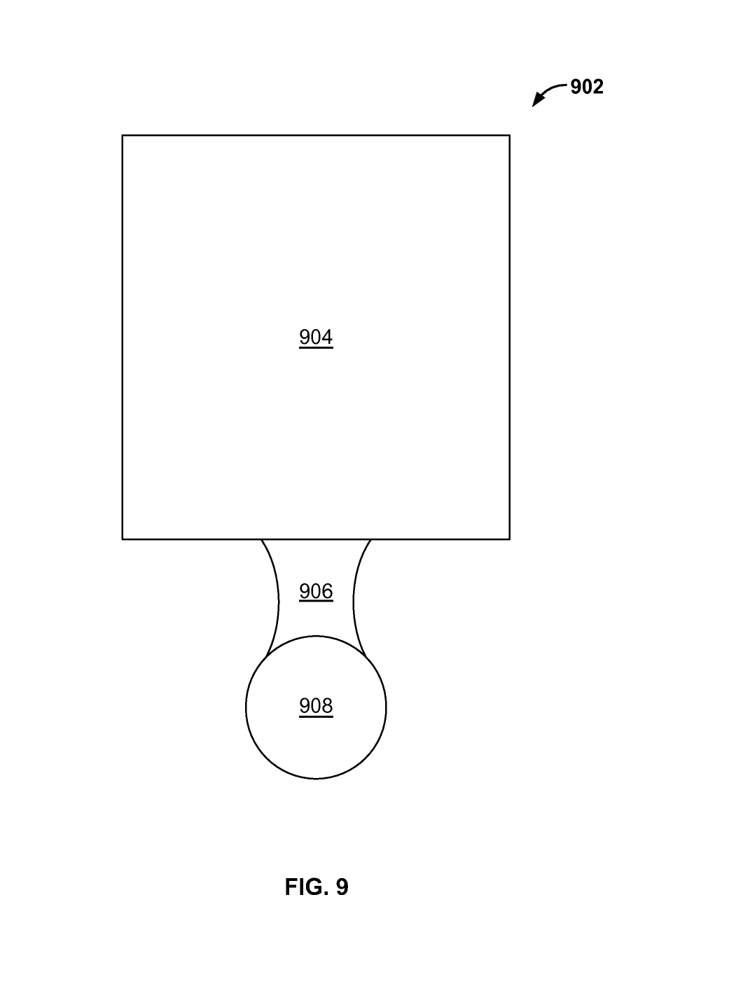

FIG. 9 illustrates another card with embedded code that includes a device interface portion and a user interface portion in accordance with some embodiments. In some embodiments, the card 902 includes a device interface zone 904 that is rectilinear, and the user device bridge 906 and the user interface zone 908 are each curvilinear as shown.

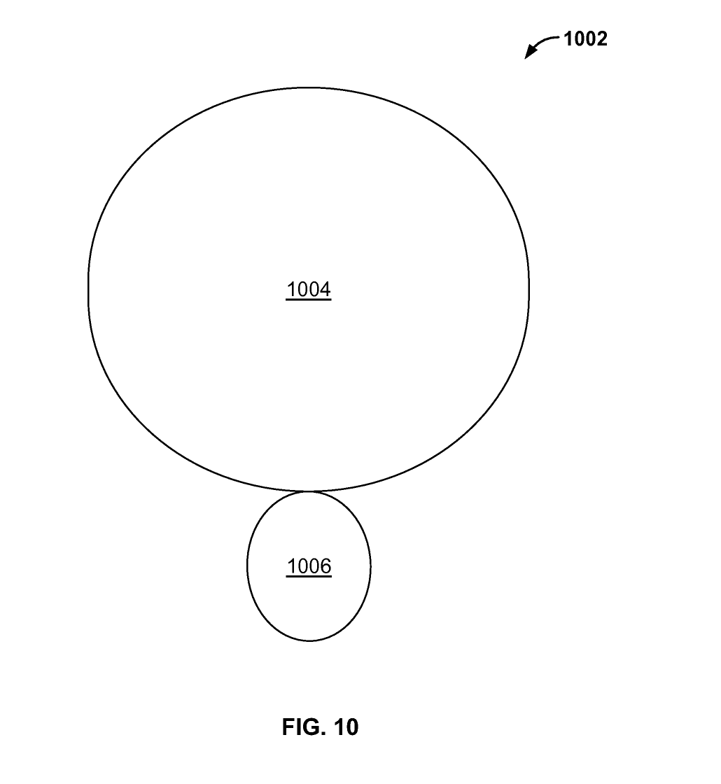

FIG. 10 illustrates another card with embedded code that includes a device interface portion and a user interface portion in accordance with some embodiments. In some embodiments, the card 1002 includes a device interface zone 1004 and a user interface zone 1006 that are connected directly (e.g., no user device bridge area is provided). As shown, each of these areas is elliptical in shape (e.g., or curvilinear or round in shape).

FIG. 11A is another view of a card with embedded code that includes a device interface portion and a user interface portion. As shown, FIG. 11A illustrates a card 1102 from a rotated left view that includes a device interface zone 1104, a device bridge 1106, and a user interface zone 1108.

FIG. 11B is a functional diagram illustrating the use of a card in use during an attempted reading of the embedded code on the card when the user interface zone overlaps with the device interface zone. As shown, FIG. 11B illustrates a side view of the card 1102 of FIG. 11A as it is being placed in contact with a touch screen device 410 such that . . . As shown, this means that the user is in contact with the device, and as a result, there will likely be an error in the reading of the embedded code on the card.

In some embodiments, cards disclosed herein can be used for various types of applications, such as trading cards, cards for games, cards used for currency. For example, cards can be provided for games that include the use of physical cards that represent certain values, characters, and/or objects in the game play (e.g., online game play). As another example, cards can also be used in a game that allows for or encourages physical trading, such as in online game play. Various types of games include the physical trading of physical cards as representative of or metaphors for the physical trading of real objects in the physical world, not just online or virtual trading of digital or virtual objects (e.g., physical trading of game cards or other physical objects). Various other types of applications and uses of cards such as the various embodiments described herein can be provided as will now be apparent to one of ordinary skill in the art in view of the various embodiments described herein.

In some embodiments, various other shapes and sizes (and combinations thereof) of cards with embedded cards are provided. In some embodiments, various other shapes and sizes of cards with embedded cards also include an electrical interconnection path as similarly described above with respect to FIG. 2 and/or a user holding pad as similarly described above with respect to FIG. 3. In some embodiments, a user device bridge area is provided (e.g., in various shapes and sizes, and generally, as a relatively smaller area than the device interface zone). In some embodiments, a user device bridge is not provided, and rather, the device interface zone and the user interface zone are connected directly. In some embodiments, various other card designs can be provided that include various other shapes and sizes of cards that include embedded code and provide a device interface portion and a user interface portion that can be connected, for example, directly or through a user device bridge as will now be apparent to one of ordinary skill in the art in view of the various embodiments described herein.

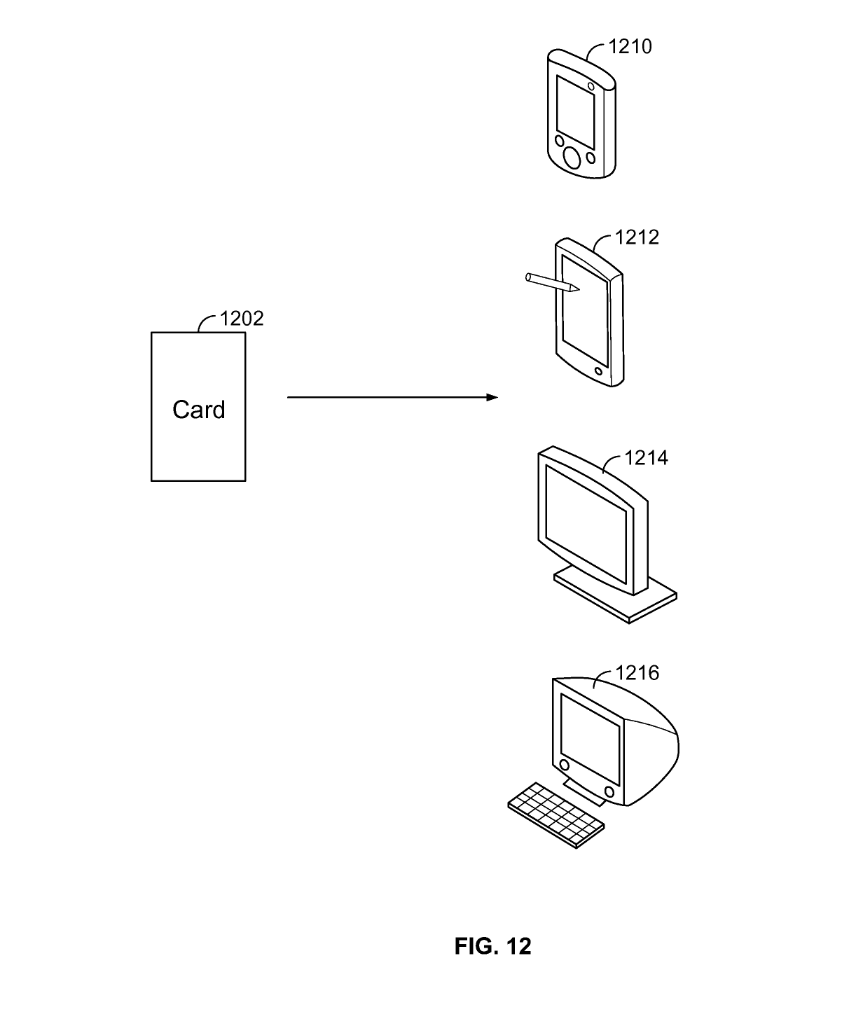

FIG. 12 illustrates a card with embedded code and various devices capable of reading the embedded code on the card in accordance with some embodiments. As shown, a card 1202 with embedded code can be read by various types of devices, including a smart phone 1210, a tablet 1212, a laptop computer 1214, and a desktop computer 1216 that are capable of reading the embedded code on the card 1202 (e.g., include a capacitive touch screen and executable software capable of reading the embedded code).

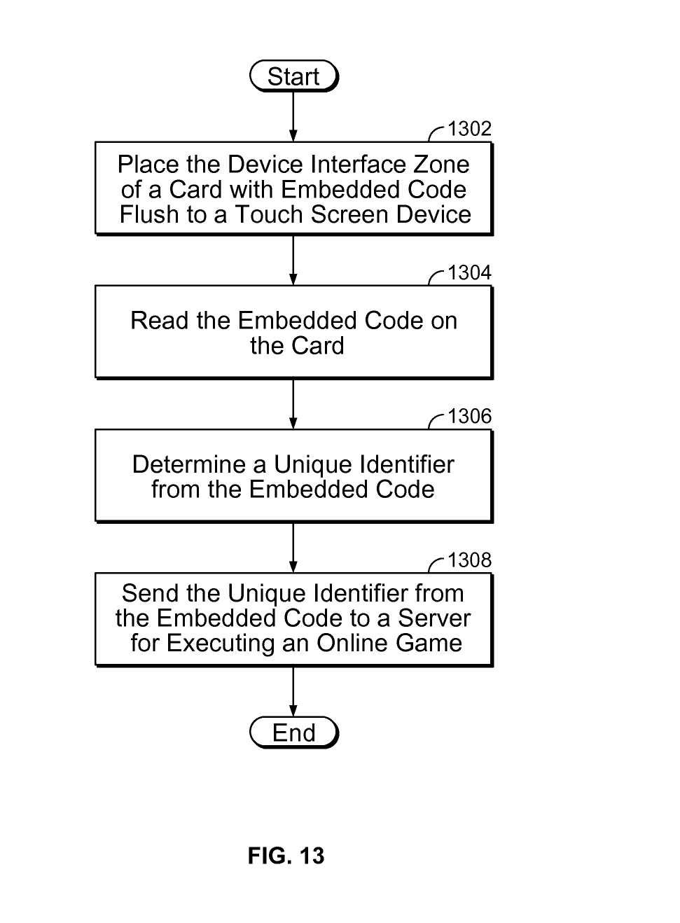

FIG. 13 is a flow diagram illustrating a process for using a card with embedded code with an online game in accordance with some embodiments. At 1302, a device interface zone portion of a card with embedded card is placed flush to a touch screen device. At 1304, the embedded code on the card is read (e.g., by executing software on the touch screen device). At 1306, a unique identifier (e.g., and/or other coded information) is determined from the embedded code. At 1308, the unique identifier from the embedded code is sent to a server for executing an online game. In some embodiments, the online game is executed locally on the touch screen device. In some embodiments, the online game is a distributed implementation that executes in part locally on the touch screen device and in part remotely on one or more servers (e.g., for a multi-user online game platform).

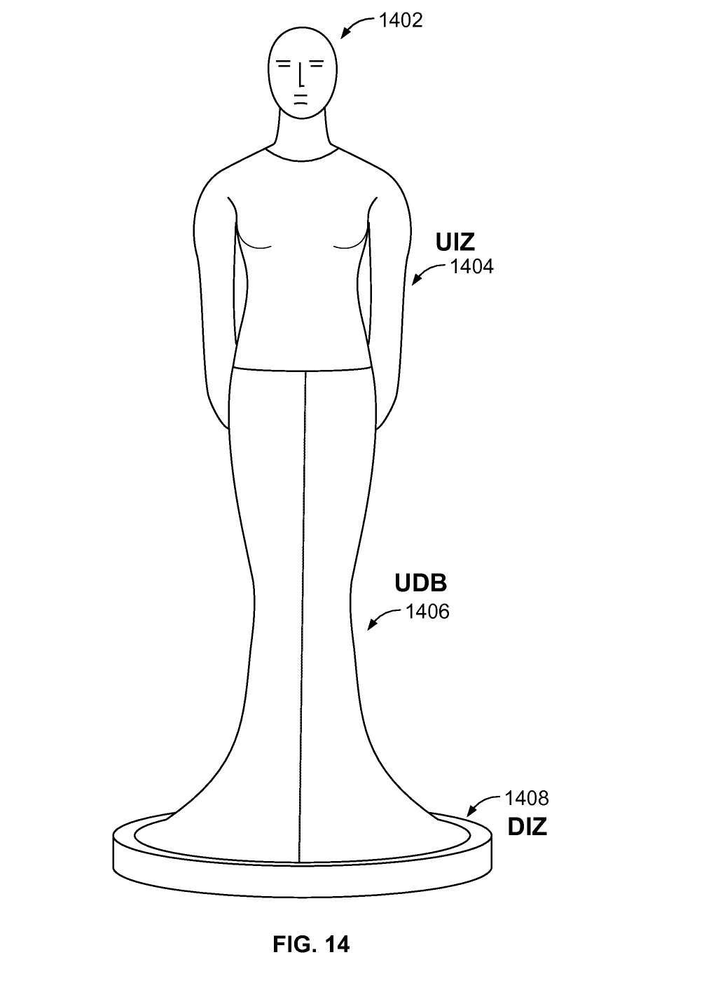

FIG. 14 illustrates a three dimensional (3-D) object with embedded code that includes a device interface portion and a user interface portion in accordance with some embodiments. In some embodiments, the techniques described herein can be applied to various shapes and sizes of three-dimensional (3-D) objects (e.g., such that the UIZ is a portion of the 3-D object that can be held by a user and the DIZ is a portion of the 3-D object that can be in contact with a touch screen of a device). As shown in FIG. 14, a 3-D object (e.g., a statue or another form of 3-D object) with embedded code includes a device interface portion (DIZ) 1408 and a user interface portion (UIZ) 1404. As also shown, the UIZ 1404 and DIZ 1408 are connected by the user device bridge portion (UDB) 1406. For example, the embedded code can be printed on the base portion of the statue 1402 (e.g., on the base of the DIZ 1408) such that a user can hold the statue 1402 by the UIZ 1404 so that the base of the DIZ 1408 is in contact with a touch screen of a device for reading the embedded code on the 3-D object 1402.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A card with embedded code, comprising:
a device interface zone, wherein the device interface zone includes an embedded code; and
a user interface zone, wherein the user interface zone is for a user to hold the card.

2. The card of claim 1, further comprising:
a user device bridge, wherein the user device bridge connects the device interface zone and the user interface zone.

3. The card of claim 1, further comprising:
an electrical interconnection path between the device interface zone and the user interface zone.

4. The card of claim 1, further comprising:
a user device bridge, wherein the user device bridge connects the device interface zone and the user interface zone, and wherein the user device bridge includes an electrical interconnection path between the device interface zone and the user interface zone.

5. The card of claim 1, further comprising:
a user device bridge, wherein the user device bridge connects the device interface zone and the user interface zone, wherein the user device bridge includes an electrical interconnection path between the device interface zone and the user interface zone, and wherein the user interface zone includes a user contact pad.

6. The card of claim 1, further comprising:
a user device bridge, wherein the user device bridge connects the device interface zone and the user interface zone, and wherein the user device bridge is relatively more flexible than the device interface zone, whereby the user device bridge facilitates a user holding the card by the user interface zone to place the card in flush contact with a capacitive screen of a device for reading the embedded code on the card, wherein the embedded code was printed on the card.

7. The card of claim 1, wherein the device interface zone and the user interface zone are rectilinear in shape.

8. The card of claim 1, wherein the device interface zone and the user interface zone are elliptical in shape.

9. The card of claim 1, wherein the device interface zone and the user interface zone are curvilinear in shape.

10. The card of claim 1, wherein the device interface zone is directly connected to the user interface zone.

11. The card of claim 1, wherein the user interface zone is relatively more flexible than the is device interface zone.

12. The card of claim 1, wherein the user interface zone includes a user contact pad.

13. The card of claim 1, wherein the embedded code is for an online game.

14. The card of claim 1, wherein the embedded code is for an online game, and wherein the embedded code is associated with an online attribute for use in the online game.

15. The card of claim 1, wherein the embedded code includes a unique identifier for an online game.

16. A method for a card with embedded code, comprising:
reading an embedded code on a device interface zone using a capacitive touch screen of a device, wherein the device interface zone includes the embedded code printed on an area of the device interface zone of the card; and
wherein the card further comprises a user interface zone, wherein the user interface zone is for a user to hold the card flush to the capacitive touch screen of the device.

17. The method of claim 16, further comprising:
determining a unique identifier from the embedded code, wherein the unique identifier is used for an online game.

18. The method of claim 16, further comprising:
determining a unique identifier from the embedded code, wherein the unique identifier is used for an online game; and
communicating the unique identifier from the embedded code to a server for executing the online game.

19. The card of claim 16, wherein the card further includes a user device bridge, and wherein is the user device bridge connects the device interface zone and the user interface zone.

20. The card of claim 16, wherein the card further includes an electrical interconnection path between the device interface zone and the user interface zone.

21. An object with embedded code, wherein the object is a three-dimensional object, comprising:
a device interface zone, wherein the device interface zone includes an embedded code; and
a user interface zone, wherein the user interface zone is for a user to hold the card.
